(19) United States
(12) Patent Application Publication
(10) Pub. No.: US 2024/0424592 A1
(43) Pub. Date: Dec. 26, 2024

(54) WELDING TORCH AND COOLING METHOD FOR WELDING TORCH

(71) Applicant: Kabushiki Kaisha Kobe Seiko Sho (Kobe Steel, Ltd.), Kobe-shi (JP)

(72) Inventors: Jinjiang WANG, Fujisawa-shi (JP); Tetsuya NAKAO, Fujisawa-shi (JP); Akira OGAWA, Fujisawa-shi (JP)

(73) Assignee: Kabushiki Kaisha Kobe Seiko Sho (Kobe Steel, Ltd.), Kobe-shi (JP)

(21) Appl. No.: 18/749,704

(22) Filed: Jun. 21, 2024

(30) Foreign Application Priority Data
Jun. 26, 2023 (JP) 2023-104334

(51) Int. Cl. B23K 9/173; B23K 37/00; B25J 11/00

(52) U.S. Cl. CPC B23K 9/173; B23K 37/003; B25J 11/005

(57) ABSTRACT

A welding torch includes a torch barrel to which a tip body is attached, and an external cylinder. The torch barrel has outer and inner barrel cylinders. An outer peripheral surface of the inner barrel cylinder is provided with coolant supply and recovery channels. The inner barrel cylinder has an inner-cylinder exposure section. A base end of an outer peripheral surface of the inner-cylinder exposure section is provided with supply and recovery openings. An axial distal end of the inner-cylinder exposure section is provided with a connection section that is connected to the tip body such that the tip body covers an outer periphery of the inner-cylinder exposure section. At least the connection section and the supply and recovery openings are disposed within the external cylinder. A seal section hermetically seals between the external cylinder and the tip body and between the external cylinder and the outer barrel cylinder.

### BACKGROUND OF THE INVENTION

### 1. Field of the Invention

The present invention relates to welding torches and cooling methods for the welding torches.

### 2. Description of the Related Art

Normally, when welding current applied during welding becomes high, radiant heat of an arc increases, thus resulting in an increase in temperature of a welding torch. In particular, a significant increase in temperature occurs at a nozzle as well as at a contact tip at the distal end of the welding torch located near where the arc occurs. An increase in temperature of the welding torch may possibly lead to an increase in wear of the contact tip and to an increase in the amount of spatter adhering to the nozzle. Moreover, a fastening section that couples the contact tip and a tip body to each other may possibly burn. Therefore, a configuration disclosed in the related art involves providing the welding torch with a water-cooling mechanism to efficiently cool the welding torch.

Japanese Unexamined Patent Application Publication No. 2020-93270 describes a welding torch having a forward water channel and a return water channel for cooling inside the tip body and the nozzle, so that a coolant is circulated to the distal end of the welding torch in the axial direction thereof.

### SUMMARY OF THE INVENTION

Although the welding torch described in Japanese Unexamined Patent Application Publication No. 2020-93270 is capable of circulating the coolant to the distal ends of the tip body and the nozzle in the axial direction, the tip body and the nozzle, which are consumables, have complex structures and thus lead to high costs. Moreover, since a cavity for cooling is provided inside the tip body, processing for providing other special mechanisms cannot be performed on the tip body. This is problematic in terms of low versatility.

The present invention has been made in view of the circumstances described above, and an object thereof is to provide a highly-versatile welding torch that has a simple structure and that can be efficiently cooled with a low-cost configuration, and to provide a cooling method for the welding torch.

The aforementioned object of the present invention is achieved in accordance with the following configuration.

(1) A welding torch used in gas-shielded arc welding includes: a torch barrel having a distal end to which a tip body is attached; and an external cylinder attached to the torch barrel so as to be externally fitted to the torch barrel. The torch barrel has an outer barrel cylinder and an inner barrel cylinder fitted in the outer barrel cylinder. An outer peripheral surface of the inner barrel cylinder is provided with a supply channel and a recovery channel. The supply channel supplies a coolant between the inner barrel cylinder and the outer barrel cylinder. The recovery channel recovers the coolant between the inner barrel cylinder and the outer barrel cylinder. The inner barrel cylinder has an inner-cylinder exposure section extending toward the distal end in an axial direction relative to the outer barrel cylinder. A base end of an outer peripheral surface of the inner-cylinder exposure section is provided with a supply opening at a distal end of the supply channel in the axial direction and a recovery opening at a distal end of the recovery channel in the axial direction. A rear end of the tip body is provided with a connection section to which a distal end of the inner-cylinder exposure section in the axial direction is connected. The connection section is provided to cover an outer periphery of the inner-cylinder exposure section. The external cylinder has an interior section internally fitted with at least the connection section, the supply opening, and the recovery opening. The interior section is provided with a seal section that hermetically seals between the external cylinder and the tip body and between the external cylinder and the outer barrel cylinder.

(2) In the welding torch according to (1), the seal section may at least have an insulator and a waterproof member, and the waterproof member may hermetically seal between an outer peripheral surface of the insulator and the external cylinder disposed radially outward of the insulator or between an inner peripheral surface of the insulator and the tip body or the outer barrel cylinder disposed radially inward of the insulator.

(3) The welding torch according to (1) may further include a tubular attachment body that is inserted in the torch barrel and whose movement in the axial direction toward the distal end is regulated by a regulating section provided at the torch barrel. The external cylinder may be fastened to the attachment body toward the distal end in the axial direction relative to the regulating section, so that movement of the external cylinder in the axial direction is regulated in a state where the external cylinder is externally fitted to the tip body and the torch barrel.

(4) In the welding torch according to any one of (1) to (3), the tip body may have a decentering guide section having a first inner diameter and a wire pressing section that decenters, in a radial direction, a welding wire inserted in the decentering guide section. A contact tip connected to a distal end of the tip body in the axial direction may extend in the axial direction from a distal-end opening provided at the distal end to a rear-end opening, and may be provided with a guide hole that guides the welding wire. The guide hole may have a second inner diameter smaller than the first inner diameter.

(5) The welding torch according to (4) may further include a base-end guide section having a third inner diameter at a base end of the decentering guide section. The third inner diameter may be smaller than the first inner diameter and larger than the second inner diameter.

(6) In the welding torch according to (4), the wire pressing section may at least have a pressing member and an elastic member. The pressing member comes into contact with the welding wire. The elastic member is for pressing the pressing member against the welding wire. The pressing member may be a spherical member. The elastic member may be a plate-spring-like member.

(7) In the welding torch according to (1), the tip body may have a rear body portion and a front body portion. The rear body portion is provided with the connection section. The front body portion is detachably attached to a front end of the rear body portion.

(8) In the welding torch according to (1), the tip body may be provided with a metallic orifice.

(9) In the welding torch according to (8), the orifice may have a cylindrical cover that extends toward the distal end in the axial direction and that covers an outer peripheral surface of the tip body.

(10) A cooling method for a welding torch used in gas-shielded arc welding includes: a torch barrel having a distal end to which a tip body is attached; and an external cylinder attached to the torch barrel so as to be externally fitted to the torch barrel. The torch barrel has an outer barrel cylinder and an inner barrel cylinder fitted in the outer barrel cylinder. An outer peripheral surface of the inner barrel cylinder is provided with a supply channel and a recovery channel. The supply channel supplies a coolant between the inner barrel cylinder and the outer barrel cylinder. The recovery channel recovers the coolant between the inner barrel cylinder and the outer barrel cylinder. The inner barrel cylinder has an inner-cylinder exposure section extending toward the distal end in an axial direction relative to the outer barrel cylinder. A base end of an outer peripheral surface of the inner-cylinder exposure section is provided with a supply opening at a distal end of the supply channel in the axial direction and a recovery opening at a distal end of the recovery channel in the axial direction. A distal end of the inner-cylinder exposure section in the axial direction is provided with a connection section connected to the tip body. The connection section is connected such that the tip body covers an outer periphery of the inner-cylinder exposure section. The external cylinder has an interior section internally fitted with at least the connection section, the supply opening, and the recovery opening. The interior section is provided with a seal section that hermetically seals between the external cylinder and the tip body and between the external cylinder and the outer barrel cylinder. The cooling method includes: a supplying step for supplying the interior section with the coolant supplied from the supply opening; a cooling step for cooling the connection section by using the coolant; and a recovering step for recovering the coolant, having cooled the interior section, from the recovery opening.

According to the present invention, the tip body can be efficiently cooled with a simple and low-cost configuration in which the rear end of the tip body is extended to form a connection section that covers the distal end of the inner barrel cylinder in the axial direction. Moreover, since the connection section can also be applied to the tip body whose intermediate section in the axial direction is specially processed, higher versatility is achieved.

### BRIEF DESCRIPTION OF THE DRAWINGS

FIG. 1 is a side view schematically illustrating a welding robot equipped with a welding torch according to the present invention;

FIG. 2 is a plan view illustrating the welding torch according to the present invention;

FIG. 3 is a side view illustrating the welding torch according to the present invention;

FIG. 4 is an exploded perspective view of the welding torch according to the present invention;

FIG. 5 is a cross-sectional view of the welding torch, taken along line V-V, and illustrates a circulation path of a coolant;

FIG. 6 is a cross-sectional view of the welding torch, taken along line VI-VI, and illustrates a forced electrification mechanism;

FIG. 7 is a cross-sectional view illustrating a wire pressing section; and

FIG. 8 is a central cross-sectional view illustrating another example of a tip body.

### DESCRIPTION OF THE PREFERRED EMBODIMENTS

The configuration of a welding torch according to the present invention will be described below with reference to the appended drawings. The drawings are created for explaining the present invention, and an embodiment of the present invention is not limited to the details shown in the drawings.

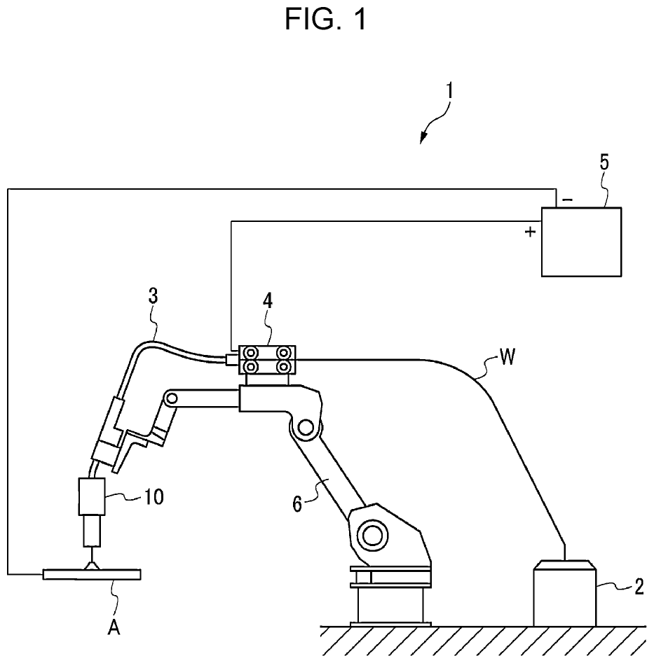

First, in order to grasp an overall image of a welding torch according to the present invention, a welding robot equipped with the welding torch will be described with reference to FIG. 1. FIG. 1 is a side view schematically illustrating the welding robot equipped with the welding torch according to the embodiment.

As shown in FIG. 1, a welding robot 1 includes a wire package 2, a torch cable 3, a wire feeder 4, a welding power source 5, a manipulator 6, and a welding torch 10. Reference sign A in FIG. 1 denotes a base material to be welded.

As shown in FIG. 1, the wire package 2 is a supply source for a welding wire W and stores therein a predetermined amount of the welding wire W. The welding wire W used may be, for example, a copper-plated wire or a non-copper-plated wire.

The torch cable 3 supplies, to the welding torch 10, welding current supplied from the welding power source 5, the welding wire W stored in the wire package 2, and shielding gas supplied from a shielding-gas storage device (not shown). The torch cable 3 has one end connected to the wire feeder 4 and the other end connected to the welding torch 10.

The wire feeder 4 unreels the welding wire W by using, for example, a roller and feeds the welding wire W to the welding torch 10 via the torch cable 3. With the wire feeder 4 provided, the welding wire W is automatically supplied to the welding torch 10.

The welding power source 5 is a supply source for welding current and supplies the welding current to the welding torch 10 via the wire feeder 4 and the torch cable 3.

The manipulator 6 is an articulated robot having the welding torch 10 attached to the distal end thereof, and the operation of the manipulator 6 is controlled by a robot controller (not shown).

In the following embodiment, the extending direction of the welding torch 10 will be referred to as “axial direction”. A direction in which the welding wire W is unreeled relative to the axial direction of the welding torch 10 will be referred to as “forward” or “distal end”. A direction opposite the unreeling direction of the welding wire W relative to the axial direction of the welding torch 10 will be referred to as “rearward” or “base end”.

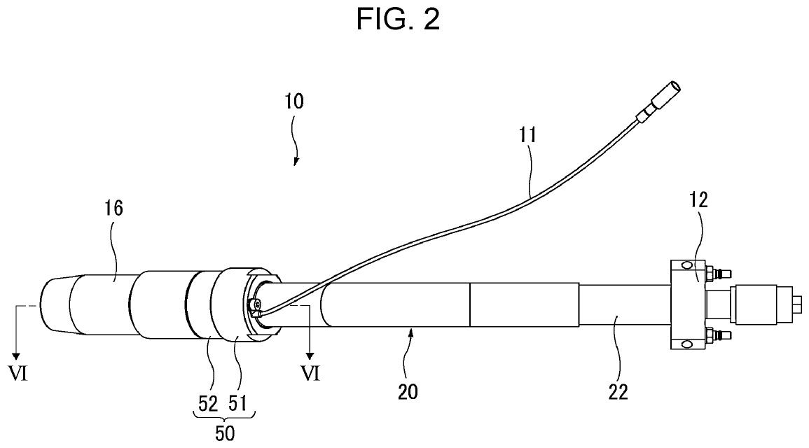

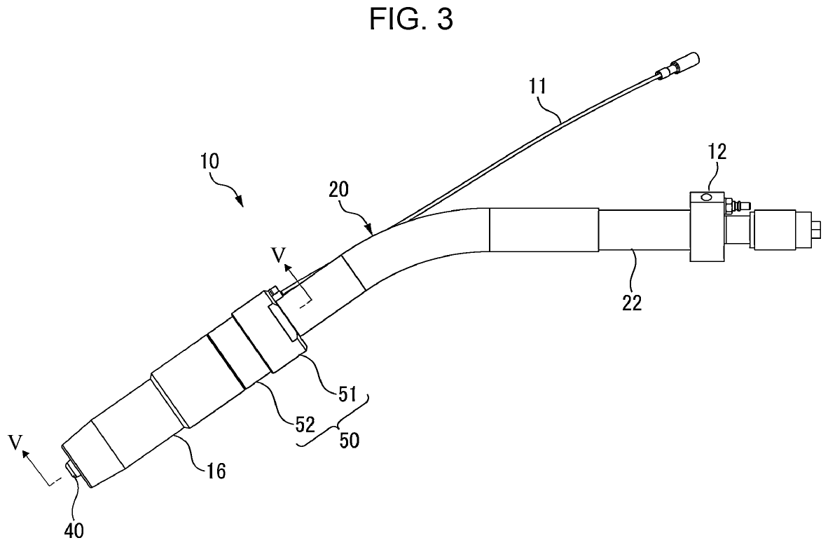

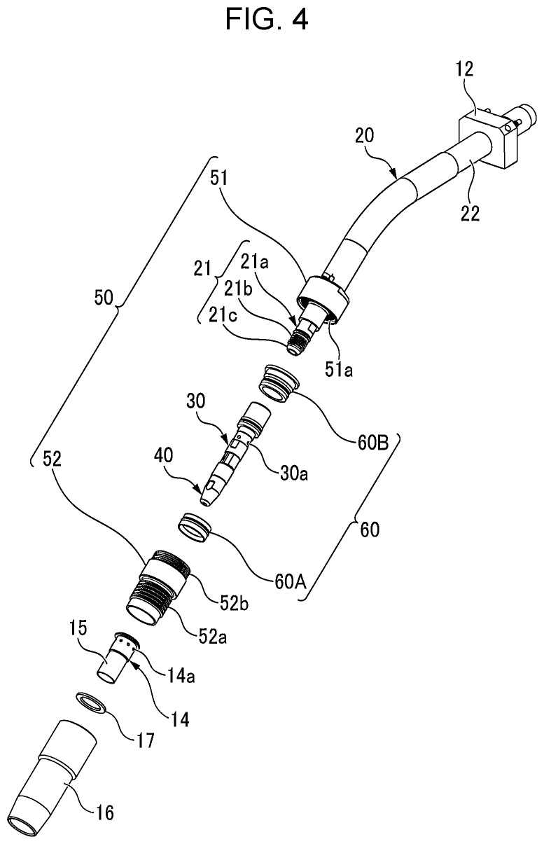

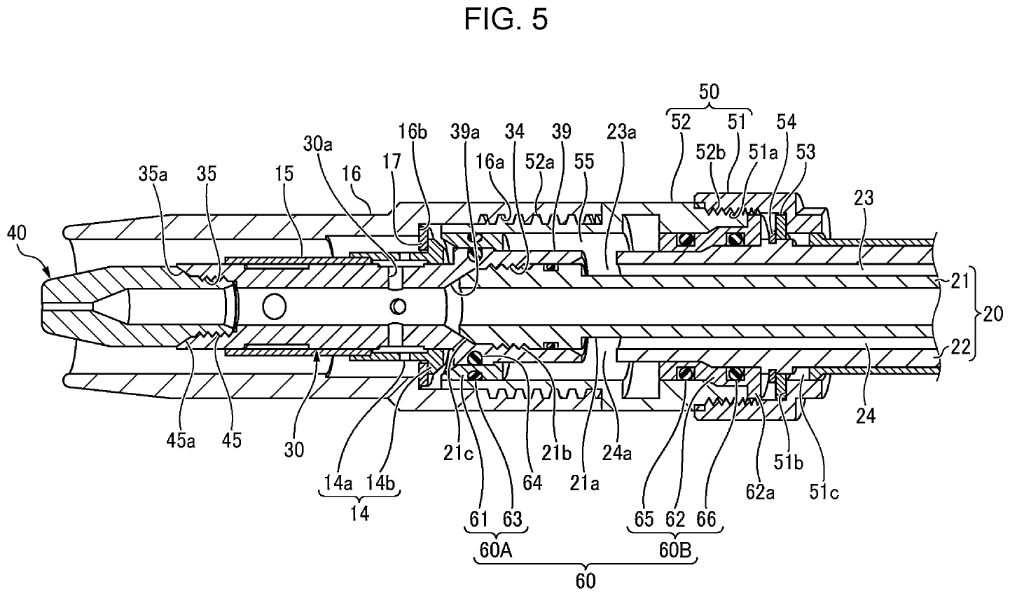

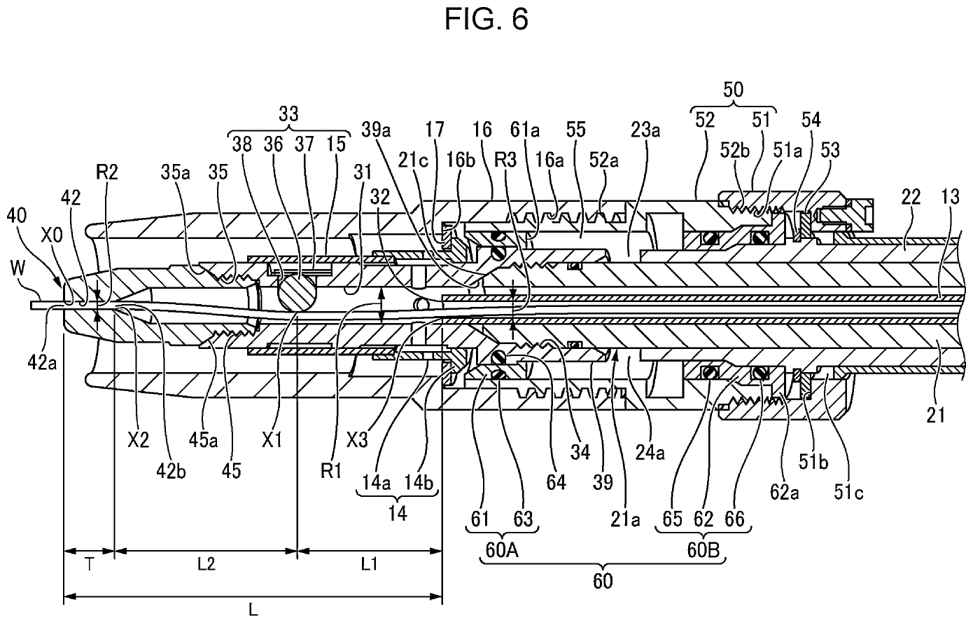

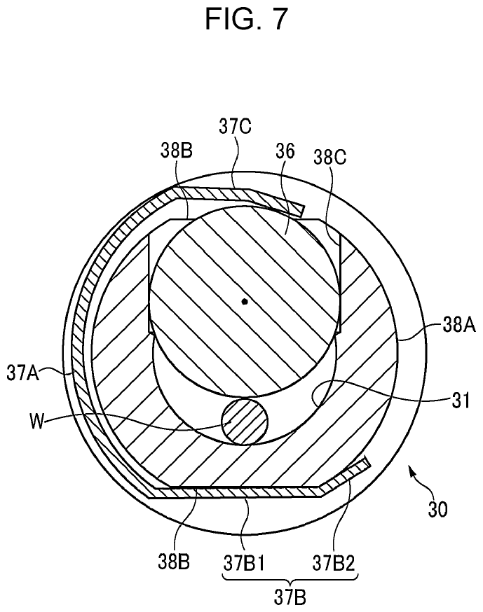

Next, the configuration of the welding torch 10 according to this embodiment will be described with reference to FIGS. 2 to 7. FIGS. 2 and 3 are a plan view and a side view, respectively, of the welding torch according to the present invention. FIG. 4 is an exploded perspective view of the welding torch according to the present invention. FIG. 5 is a cross-sectional view of the welding torch and illustrates a circulation path of a coolant. FIG. 6 is a cross-sectional view of the welding torch and illustrates a forced electrification mechanism. FIG. 7 is a cross-sectional view illustrating a wire pressing section. In FIG. 5, a conduit tube 13 and the welding wire W are not shown.

The welding torch 10 automatically receives the welding wire W fed into a cylinder and performs arc welding by using the welding wire W. As shown in FIG. 2, an electrification metal member 11 and a coolant supplying section 12 are attached to the welding torch 10.

The electrification metal member 11 is provided for detecting contact between a nozzle 16 and the base material A in accordance with voltage applied to the nozzle 16. The coolant supplying section 12 is provided for supplying and circulating the coolant to the welding torch 10.

### Welding Torch 10

As shown in FIG. 4, the welding torch 10 includes a torch barrel 20, an orifice 14, a tip body 30, a contact tip 40, a nozzle attachment mechanism 50, the nozzle 16, and a sleeve-like seal section 60.

The tip body 30 has the forced electrification mechanism that decenters the welding wire W. The forced electrification mechanism is provided as an example of a special mechanism obtained by processing an intermediate section of the tip body 30 in the axial direction.

The nozzle attachment mechanism 50 has a nut member 51 and an external cylinder 52, and attaches the nozzle 16 detachably to the distal end of the torch barrel 20.

The seal section 60 has a first seal section 60A and a second seal section 60B, and is fitted in the external cylinder 52.

### Torch Barrel 20

The torch barrel 20 has an inner barrel cylinder 21 having a cylindrical shape and an outer barrel cylinder 22 into which the inner barrel cylinder 21 is fitted. In a state where the outer surface of the inner barrel cylinder 21 is engaged with the inner surface of the outer barrel cylinder 22, the inner barrel cylinder 21 and the outer barrel cylinder 22 are combined with each other. The inner barrel cylinder 21 is longer than the outer barrel cylinder 22 so as to protrude in the axial direction from the front end and the rear end of the outer barrel cylinder 22.

The conduit tube 13 that guides the welding wire W supplied from the torch cable 3 is fitted in the inner barrel cylinder 21. The inner barrel cylinder 21 is attached such that the rear side thereof is connected to the torch cable 3 and that the tip body 30 extends at the distal end of the inner barrel cylinder 21 in the axial direction.

The inner barrel cylinder 21 has an inner-cylinder exposure section 21a extending toward the distal end in the axial direction relative to the outer barrel cylinder 22.

As shown in FIGS. 4 and 5, a pair of cut-out surfaces extending longitudinally are provided at the outer peripheral surface of the inner barrel cylinder 21 and between the inner barrel cylinder 21 and the outer barrel cylinder 22, so that a supply channel 23 for supplying the coolant and a recovery channel 24 for recovering the coolant are provided.

The base end of the inner-cylinder exposure section 21a located at a boundary position between the inner-cylinder exposure section 21a and the outer barrel cylinder 22 is provided with a supply opening 23a located at the distal end of the supply channel 23 in the axial direction and a recovery opening 24a located at the distal end of the recovery channel 24 in the axial direction.

The inner-cylinder exposure section 21a is provided with a male-threaded section 21b for fastening the tip body 30 to the distal ends of the supply opening 23a and the recovery opening 24a in the axial direction.

Furthermore, the distal end of the inner-cylinder exposure section 21a is provided with an annular slope 21c that is formed by cutting out the outer peripheral edge into an annular shape and that abuts on the tip body 30.

The base ends of the supply channel 23 and the recovery channel 24 in the axial direction are respectively provided with a supply connection section (not shown) and a recovery connection section (not shown) that are connected to the coolant supplying section 12. The supplying of the coolant to the supply channel 23 and the recovering of the coolant from the recovery channel 24 are performed by using the coolant supplying section 12 connected to the supply connection section and the recovery connection section.

### Orifice 14

The orifice 14 includes a mechanism for rectifying the shielding gas.

The orifice 14 is provided with a plurality of through-holes 14a at an equal pitch in the circumferential direction. In a state where the tip body 30 is attached, the through-holes 14a are located near through-holes 30a provided in the tip body 30 and distribute the shielding gas. Accordingly, the shielding gas flowing into the inner periphery of the orifice 14 is smoothly guided to the through-holes 14a, whereby the orifice 14 can prevent the shielding gas from flowing turbulently.

A cover 15 formed by shaping a metallic member with high thermal conductivity into a cylindrical shape is integrally attached and fixed to the front end of the orifice 14.

With the orifice 14 being attached to a predetermined position of the tip body 30, the cover 15 covers the entire perimeter of the front portion of the tip body 30. Accordingly, the thickness increases by the thickness of the cover 15 (or the orifice 14) in addition to the thickness of the tip body 30, so that the thermal-conduction cross-sectional area increases, thereby achieving enhanced cooling performance. This configuration may be confirmed by referring to FIGS. 5 and 6. Although metal with high thermal conductivity is Cu, Ag, or an alloy mainly containing either Cu or Ag, brass is the most preferable in terms of cost.

The orifice 14 has a flange 14b at the rear end thereof.

The front surface of the flange 14b is secured to a step 16b provided at the inner peripheral surface of the nozzle 16 via an insulation ring 17 inserted from the front of the orifice 14, so that forward sliding of the orifice 14 from the predetermined position is regulated.

Accordingly, an electrified situation caused as a result of the metallic orifice 14 and the metallic cover 15 coming into contact with the nozzle 16 can also be reliably prevented. This configuration may be confirmed by referring to FIGS. 4 to 6.

### Tip Body 30

The tip body 30 is a cylindrical member extending in the axial direction and includes a mechanism that supports the orifice 14 and the contact tip 40. The tip body 30 is composed of a material having electrification properties, such as metal.

The cylindrical orifice 14 is fitted to the tip body 30 from the distal end. The tip body 30 is provided with a plurality of through-holes 30a at an equal pitch in the circumferential direction. The through-holes 30a distribute the shielding gas to an area where the orifice 14 is attached. This configuration may be confirmed by referring to FIG. 4.

The inner surface at the distal end of the tip body 30 is provided with a female-threaded section 35 to which the contact tip 40 is fastened. The distal end, in the axial direction, of the female-threaded section 35 at the distal end of the tip body 30 is provided with a tapered section 35a that increases in diameter toward an opening. The rear end of the tip body 30 is provided with a connection section 39 connected to the inner barrel cylinder 21 to cover the outer peripheral surface of the inner-cylinder exposure section 21a.

The inner surface at the rear end of the connection section 39 is provided with a female-threaded section 34 to which a male-threaded section 21b provided at the front end of the inner barrel cylinder 21 is fastened. In this case, the connection section 39 at the rear end of the tip body 30 covers a front half of the inner-cylinder exposure section 21a. In other words, the connection section 39 covers the entire outer peripheral surface toward the distal end, in the axial direction, of the inner-cylinder exposure section 21a relative to the supply opening 23a and the recovery opening 24a.

The inner surface at the front portion of the connection section 39 is provided with a tapered section 39a that increases in diameter in conformity with the inner-cylinder exposure section 21a, and is in surface contact with the slope 21c provided at the distal end of the inner-cylinder exposure section 21a. Accordingly, the contact area between the tip body 30 and the inner barrel cylinder 21 can be further increased. This configuration may be confirmed by referring to FIGS. 5 and 6.

Next, the forced electrification mechanism provided in the tip body 30 and the contact tip 40 will be described with reference to FIGS. 6 and 7.

The tip body 30 guides the welding wire W supplied from the torch barrel 20 at the rear side toward the contact tip 40 at the front side.

The tip body 30 includes a wire pressing section 33 that decenters the inserted welding wire W, a decentering guide section 31 that provides a cylindrical space (referred to as “pressing space” hereinafter) where the welding wire W is decentered, and a base-end guide section 32 that provides a cylindrical space disposed at the rear side of the decentering guide section 31. This configuration may be confirmed by referring to FIG. 6.

The inner peripheral surface of the tip body 30 is provided with the pressing space provided by the decentering guide section 31. The decentering guide section 31 is disposed at a front half of the tip body 30 and is provided with the wire pressing section 33 at the intermediate section in the axial direction. The pressing space in the decentering guide section 31 has a first inner diameter R1 designed in advance.

The wire pressing section 33 includes a spherical pressing member 36 that presses against the welding wire W inserted into the decentering guide section 31, a biasing member 37 that biases the pressing member 36 radially outward, a retaining section 38 provided in the tip body 30 to retain the pressing member 36 and the biasing member 37, and the cover 15 that covers the pressing member 36 and the biasing member 37 along the outer peripheral surface of the tip body 30. This configuration may be confirmed by referring to FIG. 6.

The retaining section 38 has a recess 38A recessed along the outer surface of the decentering guide section 31 entirely in the circumferential direction, a pair of cut-out surfaces 38B provided at 180° symmetrical positions with respect to a cylindrical base surface of the recess 38A, and a through-hole 38C extending in the radial direction between one of the cut-out surfaces 38B and the pressing space. The diameter of the through-hole 38C may be slightly larger than the width of each cut-out surface 38B. This configuration may be confirmed by referring to FIG. 7.

The pressing member 36 is a steel ball engaged with and accommodated in the through-hole 38C, and is retained in a movable manner in the radial direction along the through-hole 38C. The diameter of the pressing member 36 is larger than the first inner diameter R1 of the decentering guide section 31 and smaller than the outer diameter of the decentering guide section 31. Therefore, the steel ball serving as the pressing member 36 can be prevented from entering the decentering guide section 31.

The biasing member 37 is a plate spring that is C-shaped along the recess 38A. The biasing member 37 has a pair of clamping sections 37B and 37C that clamp the pair of cut-out surfaces 38B, and also has a coupling section 37A that extends in a circular-arc shape along the recess 38A and that couples the pair of clamping sections 37B and 37C to each other. An example of the C-shaped plate spring is a rod clamp. The one clamping section 37C bends inward to press the spherical pressing member 36 into the through-hole 38C in the pressing direction. The other clamping section 37B has an abutment surface 37B1 that abuts on the corresponding cut-out surface 38B entirely in the width direction, and also has a securing section 37B2 bent relative to the abutment surface 37B1 such that an end of the clamping section 37B conforms with the recess 38A. This configuration may be confirmed by referring to FIG. 7.

The cover 15 is a cylindrical member integrally attached and fixed to the orifice 14. The cover 15 is longer in the axial direction than the recess 38A. With the orifice 14 being externally fitted to the predetermined position of the tip body 30, the cover 15 is attached to cover the entire recess 38A.

With the cover 15 covering the outer periphery of the recess 38A having the pressing member 36 and the biasing member 37 set therein, the pressing member 36 can be reliably prevented from falling out of the through-hole 38C during a welding process.

Specifically, the cover 15 has a function for enhancing the cooling properties of the tip body 30 and a function of a cover for covering the pressing member 36.

The base-end guide section 32 is disposed at the inner peripheral surface of the connection section 39 and is constituted by a distal end portion of the conduit tube 13 fitted in the inner-cylinder exposure section 21a fastened to the inner peripheral surface of the connection section 39.

The inner diameter of the conduit tube 13 defines a third inner diameter of the base-end guide section 32. As shown in FIG. 6, a third inner diameter R3 is smaller than the first inner diameter R1.

### Contact Tip 40

The contact tip 40 is a cylindrical member extending in the axial direction and has a circular truncated cone shape whose front half decreases in diameter toward the distal end. The distal end of the contact tip 40 is provided with a distal-end opening 42a from which the welding wire W is unreeled. The contact tip 40 is composed of a metallic material having electrification properties, such as copper, and supplies welding current to the welding wire W.

The rear end of the contact tip 40 is provided with a male-threaded section 45 that is fastened to the female-threaded section 35 at the distal end of the tip body 30 in the axial direction.

The front side of the male-threaded section 45 of the contact tip 40 in the axial direction is provided with a slope 45a that abuts on the tapered section 35a provided at the distal end of the female-threaded section 35 of the tip body 30 in the axial direction.

Accordingly, the contact area between the contact tip 40 and the tip body 30 can be increased.

The inner surface of the contact tip 40 has a tubular coupling section 44, a tapered section 43 that decreases in diameter from the front end of the coupling section 44 toward the front side in the axial direction, and a guide hole 42 that guides the welding wire W. The guide hole 42 extends in the axial direction from a rear-end opening 42b to the distal-end opening 42a. The rear-end opening 42b communicates with the distal end of the tapered section 43.

The guide hole 42 is provided along the center axis of the contact tip 40 and has a distal-end guide length T and a second inner diameter R2. The distal-end guide length T is the length in the axial direction from the distal-end opening 42a to the rear-end opening 42b. The second inner diameter R2 is smaller than the first inner diameter R1 and the third inner diameter R3, and is larger than a wire diameter of the welding wire W.

The distal-end guide length T and the second inner diameter R2 are set to cause the welding wire W decentered by the wire pressing section 33 from the center axis of the tip body 30 and the contact tip 40 to come into contact with the rear-end opening 42b and the distal-end opening 42a located at the rear and front ends of the guide hole 42. This configuration may be confirmed by referring to FIG. 6. In detail, the second inner diameter R2 is desirably set to 1.05 to 1.35 times the wire diameter of the welding wire W.

The tapered section 43 gradually decreases in diameter from the rear end toward the front end. In the shown example, the rear end of the tapered section 43 communicates with the front end of the coupling section 44 whose diameter is larger than the first inner diameter R1, and the front end of the tapered section 43 communicates with the rear-end opening 42b of the guide hole 42 having the second inner diameter R2.

The shapes of the tapered section 43 and the coupling section 44 are not limited to those described above, so long as the welding wire W bent by the wire pressing section 33 does not come into contact with the tip body 30 and the contact tip 40 between the pressing position of the welding wire W by the pressing member 36 and the rear-end opening 42b of the guide hole 42.

According to the contact tip 40 and the tip body 30 equipped with the aforementioned forced electrification mechanism, the welding wire W supplied from the torch barrel 20 is decentered by the wire pressing section 33 and comes into contact with the tip body 30 and the contact tip 40 at a third contact position X3 located at the distal-end position of the base-end guide section 32 (conduit tube 13) having the third inner diameter R3, a first contact position X1 pressed by the pressing member 36 within the decentering guide section 31 having the first inner diameter R1, a second contact position X2 that is near the rear-end opening 42b of the guide hole 42, and a distal-end contact position X0 that is near the distal-end opening 42a of the guide hole 42.

In this case, in the axial direction of the tip body 30 and the contact tip 40, a segment between the third contact position X3 and the first contact position X1 will be defined as a first bend segment L1, and a segment between the first contact position X1 and the second contact position X2 will be defined as a second bend segment L2.

Specifically, regardless of whether or not the welding wire W has any bends, the welding wire W can be forcedly brought into contact with an area near the distal-end position of the contact tip 40 with a predetermined contact force. In other words, the welding wire W can be forcedly electrified. Accordingly, even when the distal-end opening 42a of the contact tip 40 widens due to a welding process, the supply of electricity to the welding wire W can be maintained, so that the lifespan of the contact tip 40 can be extended.

Furthermore, because the wire pressing section 33 employs the spherical pressing member 36, the pressing member 36 that decenters the welding wire W comes into point contact with the fed welding wire W and slides while rotating, so that a frictional force in the feeding direction can be reduced, thereby preventing the feeding resistance of the welding wire W from increasing more than necessary.

### Nozzle Attachment Mechanism 50

The nozzle attachment mechanism 50 has the nut member 51 provided slidably along the axis of the outer barrel cylinder 22, and also has the external cylinder 52 interposed between the nut member 51 and the nozzle 16.

The nut member 51 is a cap nut fitted through the outer barrel cylinder 22 and is provided slidably along the outer barrel cylinder 22. Accordingly, the nut member 51 functions as an attachment body for attaching the external cylinder 52 provided with the nozzle 16 to the outer barrel cylinder 22.

The nut member 51 has a closed-end cylindrical shape with a front opening. A base 51b of the nut member 51 is provided with an insertion hole 51c through which the outer barrel cylinder 22 is inserted. The front side of the inner surface of the nut member 51 is provided with a female-threaded section 51a to which the external cylinder 52 is fastened.

With regard to the nut member 51, movement thereof toward the distal end in the axial direction is regulated by a regulating member 53 and a positioning member 54.

The positioning member 54 is an annular member engaged with an annular recess provided in the outer surface at the distal end of the outer barrel cylinder 22. The regulating member 53 is a resinous ring-shaped member, and movement thereof toward the distal end in the axial direction is regulated by the positioning member 54.

With regard to the nut member 51, the regulating member 53 abuts on the base 51b so that contact with the torch barrel 20 is regulated, and the movement toward the distal end in the axial direction is regulated at a predetermined position at the distal end of the outer barrel cylinder 22. This configuration may be confirmed by referring to FIGS. 5 and 6.

The external cylinder 52 has a cylindrical shape. The inner diameter of the external cylinder 52 is larger than the outer diameter of the outer barrel cylinder 22 and the outer diameter of the tip body 30. Accordingly, the inner peripheral surface of the external cylinder 52 is at least provided with an interior section 55. The interior section 55 covers the connection section 39, has front and rear ends that are partitioned by the seal section 60, to be described later, and communicates with the supply opening 23a and the recovery opening 24a.

The interior section 55 is supplied with the coolant supplied from the supply opening 23a, and the supplied coolant is discharged from the recovery opening 24a. The front and rear ends of the interior section 55 are hermetically sealed by the seal section 60. This configuration may be confirmed by referring to FIGS. 5 and 6.

The outer surface at the distal end of the external cylinder 52 is provided with a male-threaded section 52a to which the rear end of the nozzle 16 is fastened and that serves as a mechanism for supporting the nozzle 16. The outer surface at the rear end of the external cylinder 52 is provided with a male-threaded section 52b to which the female-threaded section 51a provided in the nut member 51 is fastened.

According to the nozzle attachment mechanism 50 having the above configuration, forward sliding of the nut member 51 from the regulating member 53 is regulated. On the other hand, the rear portion of the external cylinder 52 is fastened to the front portion of the nut member 51, so that rearward sliding of the nut member 51 from the regulating member 53 is also regulated.

Specifically, with the nozzle attachment mechanism 50, the position of the torch barrel 20 in the axial direction can be fixed in the external cylinder 52 and the nut member 51. Thus, the nozzle 16 fastened to the external cylinder 52 can extend toward the distal end of the torch barrel 20 in the axial direction.

As an alternative to the above example where the nozzle 16 is detachable from the external cylinder 52, the external cylinder 52 and the nozzle 16 may be integrated with each other. In this case, the nozzle 16 is directly attached to the nut member 51 in a detachable manner.

The configuration of the regulating member 53 is not limited to that described above, so long as the nut member 51 and the external cylinder 52 can be positioned at the predetermined position at the distal end of the outer barrel cylinder 22. For example, instead of the regulating member 53 being separate from the outer barrel cylinder 22, a step that positions the nut member 51 may be integrated with the outer surface of the outer barrel cylinder 22.

### Nozzle 16

The nozzle 16 includes a mechanism for ejecting shielding gas, such as argon or carbon-dioxide gas, supplied from a gas supplier (not shown) onto the base material A to be welded.

The nozzle 16 has a tubular shape capable of accommodating therein the tip body 30, the orifice 14, and the contact tip 40 that are in an integrally assembled state.

The inner peripheral surface at the rear portion of the nozzle 16 is provided with a female-threaded section 16a to which the male-threaded section 52a of the external cylinder 52 is fastened. The female-threaded section 16a of the nozzle 16 extends to near the center of the external cylinder 52 in the front-rear direction, or rearward relative to the center in the front-rear direction. In other words, in a side view, the rear side of the female-threaded section 16a of the nozzle 16 in the front-rear direction extends to near the supply opening 23a and the recovery opening 24a. This configuration may be confirmed by referring to FIGS. 5 and 6.

Specifically, the contact area between the nozzle 16 and the external cylinder 52 can be increased as much as possible.

### Seal Section 60

The seal section 60 has the first seal section 60A at the front side in the axial direction and the second seal section 60B at the rear side in the axial direction.

The first seal section 60A is constituted by attaching O-rings serving as waterproof members 63 and 64 to a first sleeve 61. Likewise, the second seal section 60B is constituted by attaching waterproof members 65 and 66 to a second sleeve 62.

Each of the first sleeve 61 and the second sleeve 62 is a tubular insulator composed of an insulative material, such as synthetic resin, and has an insulating function for preventing electricity applied to the torch barrel 20 from flowing to the nozzle 16 via the external cylinder 52.

The waterproof members 63, 64, 65, and 66 are O-rings composed of, for example, synthetic resin or rubber, and each have a function for preventing the coolant supplied to the interior section 55 within the external cylinder 52 from leaking outward of the external cylinder 52.

The first sleeve 61 is a tube having a cylindrical shape and is disposed at the front end of the interior section 55.

The rear end of the first sleeve 61 has a securing section 61a serving as an annular protrusion protruding radially inward so as to be to secured to a step provided at the front portion of the connection section 39.

The waterproof member 63 that is ring-shaped is provided in an annular recess provided in the outer peripheral surface of the first sleeve 61. The waterproof member 63 is in close contact with the inner peripheral surface of the external cylinder 52. Specifically, the waterproof member 63 is interposed in the radial direction between the first sleeve 61 formed of an insulative member and the external cylinder 52.

The waterproof member 64 that is ring-shaped is provided in an annular recess provided in the outer peripheral surface at the front portion of the connection section 39 of the tip body 30 that abuts on the inner peripheral surface of the first sleeve 61. The waterproof member 64 is interposed in the radial direction between the first sleeve 61 and the connection section 39 of the tip body 30.

Accordingly, the first seal section 60A is obtained, in which the first sleeve 61 and the waterproof member 63 hermetically seal between the inner peripheral surface at the front end of the external cylinder 52 and the outer peripheral surface at the front side of the connection section 39 of the tip body 30. This configuration may be confirmed by referring to FIGS. 5 and 6.

The first sleeve 61 is attached and fixed in a state where the outer peripheral surface thereof is fitted within the front end of the external cylinder 52. By fastening the tip body 30 to the male-threaded section 21b of the inner-cylinder exposure section 21a, the inner peripheral surface of the first sleeve 61 comes into close contact with the connection section 39 of the tip body 30.

The second sleeve 62 is a tube having a cylindrical shape and is disposed at the rear end of the interior section 55.

The rear end of the second sleeve 62 has a flange 62a serving as an annular protrusion protruding radially outward to receive the rear end surface of the external cylinder 52.

The waterproof member 65 that is ring-shaped is provided in an annular recess provided in the outer peripheral surface at the front portion of the second sleeve 62. The waterproof member 65 is interposed in the radial direction between the outer peripheral surface of the second sleeve 62 and the inner peripheral surface of the external cylinder 52.

The waterproof member 66 that is ring-shaped is provided in an annular recess provided in the inner peripheral surface at the front portion of the second sleeve 62. The waterproof member 66 is interposed in the radial direction between the inner peripheral surface of the second sleeve 62 and the outer peripheral surface of the outer barrel cylinder 22.

Accordingly, the second seal section 60B is obtained, in which the second sleeve 62 and the waterproof members 65 and 66 hermetically seal between the inner peripheral surface at the rear end of the external cylinder 52 and the outer peripheral surface at the front portion of the outer barrel cylinder 22.

This configuration may be confirmed by referring to FIGS. 5 and 6.

The second sleeve 62 is attached and fixed in a state where the outer peripheral surface thereof is fitted within the rear end of the external cylinder 52, and the flange 62a is secured to the rear end of the external cylinder 52. By fastening the external cylinder 52 to the nut member 51, the inner peripheral surface of the second sleeve 62 comes into close contact with the outer peripheral surface of the outer barrel cylinder 22.

### Effects and Advantages

The aforementioned welding torch 10 is cooled by performing a supplying step, a cooling step, and a discharging step. The supplying step involves supplying the interior section 55 with the coolant supplied from the coolant supplying section 12 to the supply channel 23. The cooling step involves cooling the entire tip body 30 via the connection section 39 and water-cooling the nozzle 16 via the external cylinder 52 by directly water-cooling the connection section 39 of the tip body 30 by using the coolant supplied by the interior section 55. The discharging step involves discharging the water-cooling coolant circulating through the interior section 55 from the recovery channel 24.

Since the coolant supplied to the interior section 55 comes into contact with the outer surface of the connection section 39 and can be directly used for water-cooling, the cooling efficiency for the entire tip body 30 that reaches a high temperature during arc welding is enhanced, as compared with the related art.

Furthermore, with the highly versatile structure that enhances the cooling efficiency using the connection section 39 that extends rearward from the rear end of the tip body 30, the tip body 30 itself can be provided in combination with a special structure, such as the forced electrification mechanism.

The rear portion of the nozzle 16 is attached to the external cylinder 52 to cover the outer peripheral surface at the front half of the external cylinder 52. In other words, the nozzle 16 is disposed to cover from near the supply opening 23a and the recovery opening 24a to the front end of the interior section 55 via the male-threaded section 52a at the front portion of the external cylinder 52. Therefore, the coolant supplied to the interior section 55 can efficiently cool the rear portion of the nozzle 16 via the front portion of the external cylinder 52 having high thermal conductivity. This configuration may be confirmed by referring to FIG. 5. According to the above, the cooling efficiency for the welding torch 10 is enhanced with a simple and low-cost configuration.

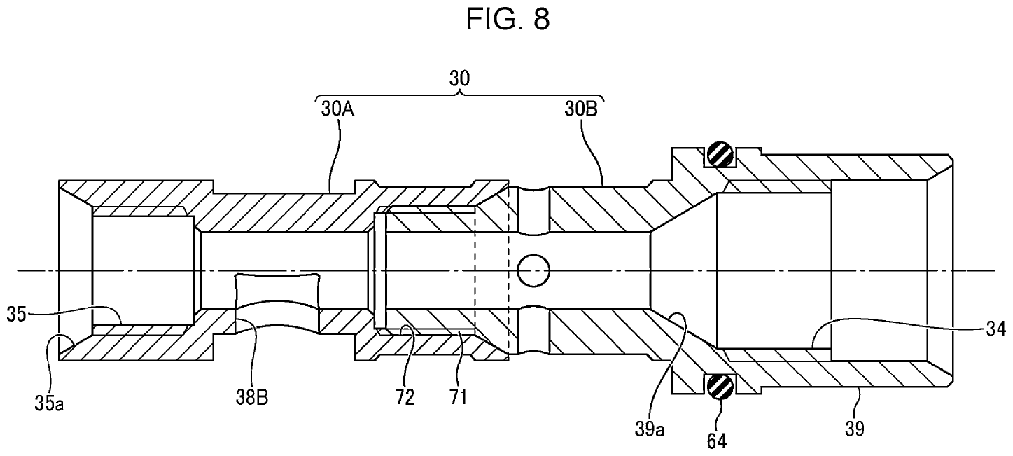

Next, another example of the tip body 30 will be described with reference to FIG. 8 while focusing on differences from the above embodiment. FIG. 8 is a cross-sectional view illustrating the tip body 30 according to this example.

The tip body 30 has a front body portion 30A and a rear body portion 30B.

The front body portion 30A is provided with the female-threaded section 35 to which the contact tip is fastened at the distal end of the front body portion 30A in the axial direction, the retaining section 38 constituting the wire pressing section 33, and a female-threaded section 72 to which the rear body portion 30B is fastened at the base end of the front body portion 30A in the axial direction.

The rear body portion 30B is provided with a male-threaded section 71 to which the female-threaded section 72 of the front body portion 30A is fastened at the distal end of the rear body portion 30B in the axial direction, and the connection section 39 to which the male-threaded section 21b of the inner-cylinder exposure section 21a is fastened at the base end of the rear body portion 30B in the axial direction.

According to the tip body 30 having the above configuration, the front body portion 30A alone can be replaced while the rear body portion 30B is maintained in the fastened state to the inner-cylinder exposure section 21a.

Specifically, the tip body 30 hermetically seals between the outer peripheral surface of the connection section 39 and the inner peripheral surface of the external cylinder 52, so that the front body portion 30A alone can be replaced without having to remove the first sleeve 61, which is relatively difficult to remove, thereby achieving improved maintenance.

The present invention is not limited to the above embodiment. Combinations of the components of the embodiment and modifications and applications by a skilled person based on the description and the known technology are expected in the present invention and are to be included in the scope demanded for protection.

Accordingly, this description discloses the following items.

(1) A welding torch used in gas-shielded arc welding, the welding torch comprising: a torch barrel having a distal end to which a tip body is attached; and an external cylinder attached to the torch barrel so as to be externally fitted to the torch barrel, wherein the torch barrel has an outer barrel cylinder and an inner barrel cylinder fitted in the outer barrel cylinder, wherein an outer peripheral surface of the inner barrel cylinder is provided with a supply channel and a recovery channel, the supply channel supplying a coolant between the inner barrel cylinder and the outer barrel cylinder, the recovery channel recovering the coolant between the inner barrel cylinder and the outer barrel cylinder, wherein the inner barrel cylinder has an inner-cylinder exposure section extending toward the distal end in an axial direction relative to the outer barrel cylinder, wherein a base end of an outer peripheral surface of the inner-cylinder exposure section is provided with a supply opening at a distal end of the supply channel in the axial direction and a recovery opening at a distal end of the recovery channel in the axial direction, wherein a rear end of the tip body is provided with a connection section to which a distal end of the inner-cylinder exposure section in the axial direction is connected, wherein the connection section is provided to cover an outer periphery of the inner-cylinder exposure section, wherein the external cylinder has an interior section internally fitted with at least the connection section, the supply opening, and the recovery opening, and wherein the interior section is provided with a seal section that hermetically seals between the external cylinder and the tip body and between the external cylinder and the outer barrel cylinder.

According to this configuration, the rear end of the tip body in the axial direction can be cooled by the coolant with a simple configuration in which the tip body covers the connection section at the distal end of the inner barrel cylinder in the axial direction, so that the tip body can be efficiently cooled with a simple and low-cost configuration, and higher versatility can be achieved.

(2) The welding torch according to (1), wherein the seal section at least has an insulator and a waterproof member, and wherein the waterproof member hermetically seals between an outer peripheral surface of the insulator and the external cylinder disposed radially outward of the insulator or between an inner peripheral surface of the insulator and the tip body or the outer barrel cylinder disposed radially inward of the insulator.

According to this configuration, since the insulator is disposed at the front-rear seal section, insulation is performed more reliably.

(3) The welding torch according to (1) or (2), further comprising a tubular attachment body that is inserted in the torch barrel and whose movement in the axial direction toward the distal end is regulated by a regulating section provided at the torch barrel, wherein the external cylinder is fastened to the attachment body toward the distal end in the axial direction relative to the regulating section, so that movement of the external cylinder in the axial direction is regulated in a state where the external cylinder is externally fitted to the tip body and the torch barrel.

According to this configuration, the external cylinder can be fixed to a predetermined attachment position by being fastened to the attachment body, thereby facilitating the assembly process.

(4) The welding torch according to any one of (1) to (3), wherein the tip body has a decentering guide section having a first inner diameter and a wire pressing section that decenters, in a radial direction, a welding wire inserted in the decentering guide section, wherein a contact tip connected to a distal end of the tip body in the axial direction extends in the axial direction from a distal-end opening provided at the distal end to a rear-end opening, and is provided with a guide hole that guides the welding wire, and wherein the guide hole has a second inner diameter smaller than the first inner diameter.

According to this configuration, the wire pressing section that stably brings the welding wire into contact with the contact tip by utilizing a reaction force of the bending rigidity of the welding wire is disposed in the tip body, so that the entire welding torch can be made compact. In addition, the configuration of the contact tip, which is replaced relatively frequently, can be simplified, thereby reducing the costs.

(5) The welding torch according to (4), further comprising a base-end guide section having a third inner diameter at a base end of the decentering guide section, wherein the third inner diameter is smaller than the first inner diameter and larger than the second inner diameter.

According to this configuration, the welding wire decentered by the wire pressing section can be deformed into an inverted-V shape, so that a contact force of the welding wire toward the contact tip becomes more stable.

(6) The welding torch according to (4), wherein the wire pressing section at least has a pressing member and an elastic member, the pressing member coming into contact with the welding wire, the elastic member being for pressing the pressing member against the welding wire, wherein the pressing member is a spherical member, and wherein the elastic member is a plate-spring-like member.

According to this configuration, the pressing member pressed against the welding wire is spherical, so that the wire pressing section can decenter the welding wire in the radial direction while preventing a force required for feeding the welding wire from the opening of the contact tip from increasing more than necessary.

(7) The welding torch according to any one of (1) to (6), wherein the tip body has a rear body portion and a front body portion, the rear body portion being provided with the connection section, the front body portion being detachably attached to a front end of the rear body portion.

According to this configuration, the front body portion at the front side of the tip body can be replaced without having to remove the seal section, thereby achieving improved maintenance.

(8) The welding torch according to any one of (1) to (7), wherein the tip body is provided with a metallic orifice.

According to this configuration, thermal conductivity is enhanced, thereby achieving improved cooling properties.

(9) The welding torch according to (8), wherein the orifice has a cylindrical cover that extends toward the distal end in the axial direction and that covers an outer peripheral surface of the tip body.

According to this configuration, the thermal-conduction cross-sectional area of the orifice increases, thereby contributing to enhanced cooling efficiency.

(10) A cooling method for a welding torch used in gas-shielded arc welding, wherein the welding torch comprises: a torch barrel having a distal end to which a tip body is attached; and an external cylinder attached to the torch barrel so as to be externally fitted to the torch barrel, wherein the torch barrel has an outer barrel cylinder and an inner barrel cylinder fitted in the outer barrel cylinder, wherein an outer peripheral surface of the inner barrel cylinder is provided with a supply channel and a recovery channel, the supply channel supplying a coolant between the inner barrel cylinder and the outer barrel cylinder, the recovery channel recovering the coolant between the inner barrel cylinder and the outer barrel cylinder, wherein the inner barrel cylinder has an inner-cylinder exposure section extending toward the distal end in an axial direction relative to the outer barrel cylinder, wherein a base end of an outer peripheral surface of the inner-cylinder exposure section is provided with a supply opening at a distal end of the supply channel in the axial direction and a recovery opening at a distal end of the recovery channel in the axial direction, wherein a distal end of the inner-cylinder exposure section in the axial direction is provided with a connection section connected to the tip body, wherein the connection section is connected such that the tip body covers an outer periphery of the inner-cylinder exposure section, wherein the external cylinder has an interior section internally fitted with at least the connection section, the supply opening, and the recovery opening, wherein the interior section is provided with a seal section that hermetically seals between the external cylinder and the tip body and between the external cylinder and the outer barrel cylinder, and wherein the cooling method comprises: a supplying step for supplying the interior section with the coolant supplied from the supply opening; a cooling step for cooling the connection section by using the coolant; and a recovering step for recovering the coolant, having cooled the interior section, from the recovery opening.

According to this configuration, the rear end of the tip body in the axial direction can be cooled by the coolant with a simple configuration in which the tip body covers the connection section at the distal end of the inner barrel cylinder in the axial direction, so that the tip body can be efficiently cooled with a simple and low-cost configuration, and higher versatility can be achieved.

1. A welding torch used in gas-shielded arc welding, the welding torch comprising:
a torch barrel having a distal end to which a tip body is attached; and
an external cylinder attached to the torch barrel so as to be externally fitted to the torch barrel,
wherein the torch barrel has an outer barrel cylinder and an inner barrel cylinder fitted in the outer barrel cylinder,
wherein an outer peripheral surface of the inner barrel cylinder is provided with a supply channel and a recovery channel, the supply channel supplying a coolant between the inner barrel cylinder and the outer barrel cylinder, the recovery channel recovering the coolant between the inner barrel cylinder and the outer barrel cylinder,
wherein the inner barrel cylinder has an inner-cylinder exposure section extending toward the distal end in an axial direction relative to the outer barrel cylinder,
wherein a base end of an outer peripheral surface of the inner-cylinder exposure section is provided with a supply opening at a distal end of the supply channel in the axial direction and a recovery opening at a distal end of the recovery channel in the axial direction,
wherein a rear end of the tip body is provided with a connection section to which a distal end of the inner-cylinder exposure section in the axial direction is connected,
wherein the connection section is provided to cover an outer periphery of the inner-cylinder exposure section,
wherein the external cylinder has an interior section internally fitted with at least the connection section, the supply opening, and the recovery opening, and
wherein the interior section is provided with a seal section that hermetically seals between the external cylinder and the tip body and between the external cylinder and the outer barrel cylinder.

2. The welding torch according to claim 1,
wherein the seal section at least has an insulator and a waterproof member, and
wherein the waterproof member hermetically seals between an outer peripheral surface of the insulator and the external cylinder disposed radially outward of the insulator or between an inner peripheral surface of the insulator and the tip body or the outer barrel cylinder disposed radially inward of the insulator.

3. The welding torch according to claim 1, further comprising:
a tubular attachment body that is inserted in the torch barrel and whose movement in the axial direction toward the distal end is regulated by a regulating section provided at the torch barrel,
wherein the external cylinder is fastened to the attachment body toward the distal end in the axial direction relative to the regulating section, so that movement of the external cylinder in the axial direction is regulated in a state where the external cylinder is externally fitted to the tip body and the torch barrel.

4. The welding torch according to claim 1,
wherein the tip body has a decentering guide section having a first inner diameter and a wire pressing section that decenters, in a radial direction, a welding wire inserted in the decentering guide section,
wherein a contact tip connected to a distal end of the tip body in the axial direction extends in the axial direction from a distal-end opening provided at the distal end to a rear-end opening, and is provided with a guide hole that guides the welding wire, and
wherein the guide hole has a second inner diameter smaller than the first inner diameter.

5. The welding torch according to claim 4, further comprising:
a base-end guide section having a third inner diameter at a base end of the decentering guide section,
wherein the third inner diameter is smaller than the first inner diameter and larger than the second inner diameter.

6. The welding torch according to claim 4,
wherein the wire pressing section at least has a pressing member and an elastic member, the pressing member coming into contact with the welding wire, the elastic member being for pressing the pressing member against the welding wire,
wherein the pressing member is a spherical member, and
wherein the elastic member is a plate-spring-like member.

7. The welding torch according to claim 1,
wherein the tip body has a rear body portion and a front body portion, the rear body portion being provided with the connection section, the front body portion being detachably attached to a front end of the rear body portion.

8. The welding torch according to claim 1,
wherein the tip body is provided with a metallic orifice.

9. The welding torch according to claim 8,
wherein the orifice has a cylindrical cover that extends toward the distal end in the axial direction and that covers an outer peripheral surface of the tip body.

10. A cooling method for a welding torch used in gas-shielded arc welding,
wherein the welding torch comprises:
a torch barrel having a distal end to which a tip body is attached; and
an external cylinder attached to the torch barrel so as to be externally fitted to the torch barrel,
wherein the torch barrel has an outer barrel cylinder and an inner barrel cylinder fitted in the outer barrel cylinder,
wherein an outer peripheral surface of the inner barrel cylinder is provided with a supply channel and a recovery channel, the supply channel supplying a coolant between the inner barrel cylinder and the outer barrel cylinder, the recovery channel recovering the coolant between the inner barrel cylinder and the outer barrel cylinder,
wherein the inner barrel cylinder has an inner-cylinder exposure section extending toward the distal end in an axial direction relative to the outer barrel cylinder,
wherein a base end of an outer peripheral surface of the inner-cylinder exposure section is provided with a supply opening at a distal end of the supply channel in the axial direction and a recovery opening at a distal end of the recovery channel in the axial direction,
wherein a distal end of the inner-cylinder exposure section in the axial direction is provided with a connection section connected to the tip body,
wherein the connection section is connected such that the tip body covers an outer periphery of the inner-cylinder exposure section,
wherein the external cylinder has an interior section internally fitted with at least the connection section, the supply opening, and the recovery opening,
wherein the interior section is provided with a seal section that hermetically seals between the external cylinder and the tip body and between the external cylinder and the outer barrel cylinder, and
wherein the cooling method comprises:
a supplying step for supplying the interior section with the coolant supplied from the supply opening;
a cooling step for cooling the connection section by using the coolant; and
a recovering step for recovering the coolant, having cooled the interior section, from the recovery opening.

11. The welding torch according to claim 2,
wherein the tip body has a decentering guide section having a first inner diameter and a wire pressing section that decenters, in a radial direction, a welding wire inserted in the decentering guide section,
wherein a contact tip connected to a distal end of the tip body in the axial direction extends in the axial direction from a distal-end opening provided at the distal end to a rear-end opening, and is provided with a guide hole that guides the welding wire, and
wherein the guide hole has a second inner diameter smaller than the first inner diameter.

12. The welding torch according to claim 3,
wherein the tip body has a decentering guide section having a first inner diameter and a wire pressing section that decenters, in a radial direction, a welding wire inserted in the decentering guide section,
wherein a contact tip connected to a distal end of the tip body in the axial direction extends in the axial direction from a distal-end opening provided at the distal end to a rear-end opening, and is provided with a guide hole that guides the welding wire, and
wherein the guide hole has a second inner diameter smaller than the first inner diameter.
